(19) United States
(12) Patent Application Publication
(10) Pub. No.: US 2009/0310042 A1
(43) Pub. Date: Dec. 17, 2009

(54) Illumination system and method with efficient polarization recovery

(76) Inventors: Marcial Vidal, Merritt Island, FL (US); Haizhang Li, Orlando, FL (US); Zhisheng Yun, Oldsmar, FL (US)

Correspondence Address: RONALD J. MEETIN, ATTORNEY AT LAW, 210 CENTRAL AVENUE, MOUNTAIN VIEW, CA, 94043-4869, US

(21) Appl. No.: 12/214,170

(22) Filed: Jun. 16, 2008

(51) Int. Cl. G02F 1/1335; G02B 27/18

(52) U.S. Cl. 349/8; 362/19

(57) ABSTRACT

Light provided by a light-reflective light source (102) in an illumination system having polarization recovery is collimated by a collimator (104) and transmitted through a quarter-wave retardation plate (106) to produce light having orthogonal linearly polarized components of first and second linear polarization types. A light-reflective linear polarizer (108) largely transmits the first-linear-polarization-type component and reflects the second-linear-polarization-type component which is then largely converted by the retardation plate into circularly polarized light of a first handedness and directed by the collimator to the light source to be reflected forward and converted into circularly polarized light of an opposite second handedness. The circularly polarized light of the second handedness is largely collimated by the collimator, converted by the retardation plate into linearly polarized light of the first polarization type, and transmitted through the polarizer to complete the polarization recovery. A light integrator (160 or 170) causes partial fluxes of composite light collimated by the collimator and transmitted through the retardation plate and polarizer to be mixed so as to make the light illumination more uniform.

### FIELD OF USE

This invention relates to illumination systems and methods with polarization recovery.

### BACKGROUND ART

A light source that supplies linearly (or plane) polarized light is needed to illuminate a liquid-crystal display (“LCD”) panel, either reflective or transmissive, such as that of an LCD light projector. In a conventional polarizing light source formed with a linear polarizer and a light source that provides unpolarized light, a maximum of one half of the unpolarized light incident on the polarizer passes through the polarizer and is available for illumination purposes.

More particularly, light is characterized by an electric field having an electric-field vector. Unpolarized light orthogonally incident on a linear polarizer can be divided into two components having their electric field vectors respectively parallel and perpendicular to the polarization axis of the polarizer. The polarizer only transmits the light component whose electric-field vector is parallel to the polarization axis. Some transmission loss invariably occurs due to light absorption in the polarizer. As a result, the polarizer normally transmits somewhat less than half of the orthogonally incident unpolarized light.

The linear polarizer blocks the transmission of the light component whose electric-field vector is perpendicular to the polarization axis. In some situations, the light blocking occurs by absorption of that light component in the polarizer. In other situations, the light blocking occurs by substantial reflection of the light component whose electric-field vector is parallel to the polarization axis. A linear polarizer that functions in this way is commonly referred to as a light-reflective linear polarizer or simply a reflective linear polarizer.

An unpolarized light ray illustrated in a drawing is commonly described as having orthogonal “p” and “s” components. Both light components are linearly polarized. The p linearly polarized component has its electric-field vector parallel to the plane of the drawing. The s linearly polarized component has its electric-field vector perpendicular to the drawing's plane. A linear polarizer illustrated in the drawing so as to be orthogonal to the light ray is generally indicated as transmitting either the p component or the s component depending on whether the polarizer's polarization axis is parallel or perpendicular to the drawing's plane.

Linearly polarized light is an extreme type of polarized light generally referred to as elliptically polarized light. The tip of the electric-field vector of a beam of elliptically polarized light traverses an elliptical spiral in the direction of light propagation. For linearly polarized light, the elliptical spiral devolves to a plane. Another extreme type of elliptically polarized light is circularly polarized light for which the elliptical spiral devolves to a circular spiral. The division of a ray of light into orthogonal components, again commonly referred to as the p and s components, applies to elliptically polarized light, such as circularly polarized light, as long as the elliptically polarized light has not devolved into linearly polarized light.

As viewed looking upstream toward circularly polarized light, a ray of circularly polarized light whose electric-field vector traverses a circular spiral in a clockwise manner is referred to as being of left-handed circular polarization by some persons skilled in the light polarization art. A ray of circularly polarized light whose electric-field vector moves counter-clockwise is then referred to as being of right-handed circular polarization. Other persons skilled in the light polarization art use the opposite definitions of left-handedness and right-handedness for circularly polarized light.

The terms “p” and “s” are often used in describing linearly polarized components of light being propagated in an optical system without specific reference to any drawing illustrating the optical system. In such a case, the p linearly polarized component is usually the light component whose electric-field vector extends in the direction of the polarization axis of a linear polarizer in the optical system. The s linearly polarized component is then the light component whose electric-field vector extends perpendicular to the direction of the polarization axis and also perpendicular to the direction of light propagation as the light impinges orthogonally on the polarizer.

When a beam of light is reflected, the incident plane is the plane in which the incident and reflected light beams travel. The electric-field vector of p linearly polarized light is parallel to the incident plane and perpendicular to the direction of light propagation. The electric-field vector of s linearly polarized light is perpendicular to the incident plane.

Efforts have been made to recover the otherwise wasted polarization component of incident unpolarized light. A common method is to use a polarizing beam splitter (“PBS”) that transmits the p component of the incoming light beam and reflects the s component. A prism or a mirror combined with a half-wave retardation plate converts the transmitted p component into s polarized light having the same propagation direction as the reflected s component. U.S. Pat. Nos. 5,884,991 and 6,046,856 present examples of such polarization-recovery illumination systems.

The étendue, an optical-system property that characterizes the spreading of light, is basically the product of the area of the light source and the solid angle from the source to the light's target or, equivalently, the product of the area of the target and the solid angle from the target to the source. This definition of étendue applies specifically to an infinitesimal source and an infinitesimal target but typically serves as a useful approximation for a non-infinitesimal source or/and a non-infinitesimal target. In any event, the polarization-recovery illumination systems described in U.S. Pat. Nos. 5,884,991 and 6,046,856 double the étendue. Consequently, the total light provided by the polarization-recovery illumination systems of these two patents is not efficiently utilized.

Another conventional polarization-recovery technique is to use a polarizing light converter (“PLC”) formed with a pair of fly-eye lens arrays, an array of polarization-beam splitter (“PBS”) prisms, and a plurality of half-wave retardation strips. Each PBS prism is one half the width of each lens. The PLC technique, which does not increase the étendue, is used in some commercial products. U.S. Pat. Nos. 6,411,438 B1 and 6,154,320 describe polarization-recovery illumination systems employing PLCs. A disadvantage of PLCs is that they are very expensive. Also, few companies in the world have the capability to manufacture them.

Most commercial projectors currently employ short arc lamps with high étendue efficiency. However, the typical operational lifetime of these lamps is only several thousand hours. Another problem is that the lamps emit significant amount of infrared light, thus increasing the cost for heat dissipation.

Light-emitting diodes (“LEDs”) with very high brightness have recently become commercially available. High-brightness LEDs typically have long lifetime, rich color gamut, and emit essentially no infrared radiation. In addition, many high-brightness LEDs have light-reflective surfaces.

Holman et al (“Holman”), U.S. Pat. No. 6,871,982 B2, describes an LED-based polarization-recovery illumination system suitable for an LCD flat-panel display. As shown in FIG. 1, Holman's polarization-recovery illumination system includes tapered-sidewall reflecting bin 20 which contains flip-chip LED 22 and surrounding encapsulant 24. Situated above encapsulant 24 are lower prism sheet 26, upper prism sheet 28, quarter-wave light retardation layer 30, and reflective linear polarizer 32. The upper surfaces of prism sheets 26 and 28 are grooved. The grooves in upper prism sheet 28 extend perpendicular to the grooves in lower prism sheet 26 and are not visible in FIG. 1.

Flip-chip LED 22 in Holman's polarization-recovery illumination system consists of sapphire substrate 34, intermediate layers 36 (not separately demarcated in FIG. 1), and electrode structure 38 that functions as a mirror. The basic layout of electrode mirror 38 is depicted in FIG. 2. Electrode mirror 38 is formed with first electrode 38A and second electrodes 38B laterally surrounded by electrode 38A. As current flows between electrodes 38A and 38b, LED 22 generally emits light which is not linearly or circularly polarized and which is generally referred to herein as unpolarized light.

An understanding of the operation of Holman's illumination system is facilitated by examining what happens to a ray 40 of unpolarized light emitted forward (upward in the orientation of FIG. 1) by LED 22 so as to pass through intermediate LED layers 36 and sapphire substrate 34. Unpolarized ray 40 passes sequentially through encapsulant 24, lower prism layer 26, upper prism layer 28, and retardation plate 30, making directional changes generally of the nature indicated in FIG. 1. With the polarization axis of polarizer 32 extending parallel to the plane of FIG. 1, p linearly polarized component 42 of ray 40 passes through polarizer 32 while s linearly polarized component 44 of ray 40 is reflected backward by polarizer 32.

Quarter-wave retardation layer 30 is attuned to the wavelength of light emitted by LED 22. Retardation layer 30 and polarizer 32 are oriented relative to each other so that, in moving backward (downward in the orientation of FIG. 1) and passing through retardation layer 30, s linearly polarized light component 44 is converted to circularly polarized light ray 46 of left-handed circular polarization. Left-handed circularly polarized ray 46 passes sequentially through upper prism layer 28, lower prism layer 26, encapsulant 24, sapphire substrate 34, and intermediate LED layers 36, making directional changes generally of the nature indicated in FIG. 1. Upon reaching LED electrode mirror 38, left-handed circularly polarized ray 46 is reflected forward and converted to circularly polarized light ray 48 of right-handed circular polarization.

In moving forward, right-handed circularly polarized ray 48 passes sequentially through intermediate LED layers 36, sapphire substrate 34, lower prism layer 26, and upper prism layer 28, making directional changes generally of the nature indicated in FIG. 1. Due to the reversal of the circular polarization handedness at electrode mirror 38, right-handed circularly polarized ray 48 is converted to p linearly polarized light 50 in passing through retardation layer 30. Since the polarization axis of polarizer 32 extends parallel to the plane of FIG. 1, p linearly polarized ray 50 passes through polarizer 32. Hence, Holman's illumination system recovers reflected s linearly polarized light component 44 in the form of p linearly polarized ray 50.

Holman's polarization-recovery illumination system increases the étendue but, advantageously, does not cause it to double. Additionally, the grooves in prism layers 26 and 28 cause the light emitted by LED 22 to be mixed in being converted to p linearly polarized light that passes through polarizer 32. This advantageously causes the illumination to be more uniform across the area of polarizer 32 than what would occur if the upper surfaces of prism layers 26 and 28 were flat.

The ability of retardation layer 30 to convert impinging s linearly polarized light to left-handed circularly polarized light and to convert impinging right-handed circularly polarized light to p linearly polarized light is very sensitive to the impingement direction. In particular, s linearly polarized light needs to impinge on retardation layer 30 nearly perpendicularly in order to be converted to left-handed circularly polarized light. Right-handed circularly polarized light similarly needs to impinge nearly perpendicularly on retardation layer 30 in order to be converted to p linearly polarized light.

A considerable amount of the backward-propagating s linearly polarized light components produced by reflection of the unpolarized light off polarizer 32 impinges significantly non-perpendicularly on retardation layer 30, partially due to the grooves in prism layers 26 and 28. Likewise, a considerable amount of the forward propagating right-handed circularly polarized recycled light produced by reflection off electrode mirror 38 impinges significantly non-perpendicularly on retardation layer 30, also partially due to the grooves in prism layers 26 and 28. Furthermore, prism layers 26 and 28 deform the wavefront of the light transmitted backward through them. A considerable portion of the backward-traveling light does not reach electrode mirror 38 so as to be reflected forward. As a result, the polarization-recovery efficiency of Holman's illumination system is relatively low.

There is a need for an illumination system that avoids the shortcomings of the arc type discharge lamps for LCD projection applications. It would be desirable to have an illumination system which provides highly efficient polarization recovery without increasing the system étendue so that the light emitted from the system's light source can be utilized efficiently. It would also be desirable that the illumination be highly uniform.

### GENERAL DISCLOSURE OF THE INVENTION

The present invention provides such a polarization-recovery illumination system. Similar to Holman, polarization recovery in the illumination system of the invention entails utilizing quarter-wave light retardation to convert linearly polarized light to circularly polarized light, light reflection to invert the handedness of circularly polarized light, and quarter-wave light retardation to convert circularly polarized light to linearly polarized light. Different from Holman, the present illumination system employs light collimation to achieve highly efficient polarization recovery. The polarization-recovery illumination system of the invention also preferably uses light integration to achieve highly uniform light illumination.

More particularly, a polarization-recovery illumination system in accordance with the invention contains a light source, a collimator, a quarter-wave light retardation plate, and a light-reflective linear polarizer. The light source, preferably formed with an LED, includes a light reflector. By using a light-reflective LED in the light source, the present polarization-recovery illumination system can take advantage of high-brightness LEDs that are now commercially available.

The collimator collimates light provided from the light source. The retardation plate transmits light collimated by the collimator. The so-transmitted light contains orthogonal linearly polarized components of first and second linear polarization types. The polarizer transmits light of the component of the first linear polarization type and reflects light of the component of the second linear polarization type.

Polarization recovery in the present illumination system begins with the reflection of the light of the component of the second linear polarization type. The reflected light is transmitted backward through the retardation plate and thereby converted into circularly polarized light of a first handedness. The collimator directs the circularly polarized light of the first handedness to the light source's reflector where the circularly polarized light of the first handedness is reflected and converted into circularly polarized light of a second handedness opposite to the first handedness.

After being collimated by the collimator, the circularly polarized light of the second handedness is transmitted forward through the retardation plate and thereby converted into linearly polarized light of the first linear polarization type. The polarizer then transmits the linearly polarized light of the first linear polarization type to complete the polarization recovery process.

Importantly, the polarization recovery is done without increasing the étendue. Small light absorption losses invariably occur in the illumination system of the invention. However, largely all of the non-absorbed backward-reflected light reaches the light reflector of the light source and is reflected forward. By combining collimation with polarization recovery in the preceding way, the present illumination system efficiently utilizes the light provided by the light source.

Light integration is performed with an integrator that causes a plurality of partial fluxes of composite light collimated by the collimator and transmitted through the retardation plate and the polarizer to be mixed. This enables the integrator to provide a target location with integrated linearly polarized light of more uniform illumination than the composite light.

The integrator preferably includes a pair of lens arrays. One of the lens arrays is formed with a plurality of first lenses respectively corresponding to the partial light fluxes. Each first lens transmits light of the corresponding partial flux and causes that light to converge into a convergent flux of light. The other lens array is formed with a plurality of second lenses respectively corresponding to the convergent light fluxes. Each second lens transmits light of the corresponding convergent flux to produce a divergent flux of light that mixes with the other divergent light fluxes. Depending on the specific action of the second lens array, the integrator may include a focusing lens for focusing the divergent light fluxes on the target location.

The components of the integrator can be positioned in various ways relative to the other components of the present illumination system. In a preferred positioning, the first lens array is situated between the polarizer and the target location. The second lens array is then situated between the first lens array and the target location. When present, the focusing lens is situated between the second lens array and the target location.

In short, the illumination system of the invention achieves highly efficient polarization recovery without increase in the system étendue. The illumination is highly uniform. By using a high-brightness LED in the light source, the system brightness is quite high, thereby making the present illumination system particularly attractive for use in LCD light projectors. The polarization-recovery components, i.e., the reflective polarizer and the quarter-wave retardation plate, in the illumination system of the invention are considerably less expensive than PBS prism arrays used in some conventional polarization-recovery illumination systems. Consequently, the present polarization-recovery illumination system is considerably less costly than conventional prism-array-based polarization-recovery illumination systems. The invention provides a substantial advance over the prior art.

### BRIEF DESCRIPTION OF THE DRAWINGS

FIG. 1 is a cross-sectional top (or side) view of a conventional polarization-recovery illumination system which employs an LED light source.

FIG. 2 is a layout diagram of the LED light source used in the illumination system of FIG. 1.

FIGS. 3a-3d are cross-structural top (or side) views of four polarization-recovery illumination systems configured according to the invention for providing linearly polarized light.

FIG. 4 is a perspective view of the core of the light source in the illumination system of FIG. 3a or 3b.

FIG. 5 is a graph of light intensity as a function of distance along the target location for linearly polarized light provided by the illumination system of FIG. 3a or 3b.

FIGS. 6a and 6b are block diagrams/cross-structural top views of two extensions, according to the invention, of the polarization-recovery illumination systems of FIGS. 3a and 3b to include light-integration capability.

FIGS. 7a-7f are cross-structural top views of six LCD optical assemblies that respectively contain six implementations of the polarization-recovery illumination systems of FIGS. 6a and 6b.

FIGS. 8a-8d are cross-structural top views of four LCD color light projectors that respectively utilize four variations of the LCD assemblies of FIGS. 7a-7d and thus respectively employ the four polarization-recovery illumination systems of FIGS. 7a-7d.

Like reference symbols are used in the drawings and in the description of the preferred embodiments to represent the same, or very similar, item or items.

Linearly polarized light rays whose electric-field vectors point, or whose direction of polarization is, parallel to the plane of a drawing are indicated by lines having short crossing lines. Linearly polarized light rays whose electric-field vectors point, or whose direction of polarization is, perpendicular to the plane of a drawing are indicated by lines having dots. Unpolarized light rays shown on a drawing having linearly polarized light rays are indicated by lines having both dots and short crossing lines.

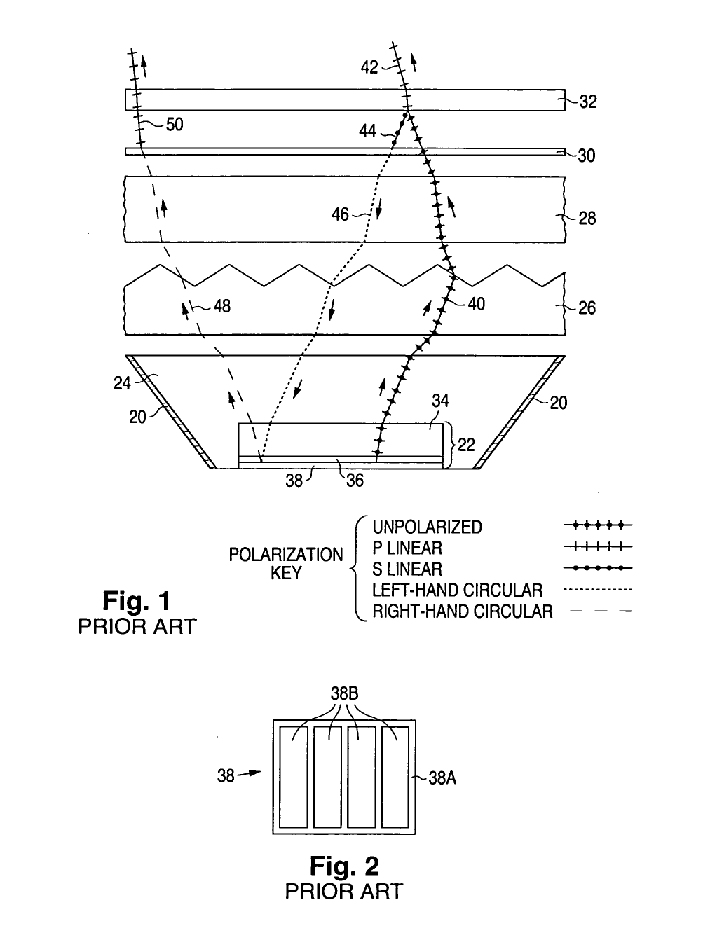

Circularly polarized light rays of the left-handedness type of circular polarization are indicated by dotted lines in the drawings. Circularly polarized light rays of the right-handedness type of circular polarization are indicated by dashed lines in the drawings. See the polarization key accompanying FIG. 1.

### DESCRIPTION OF THE PREFERRED EMBODIMENTS

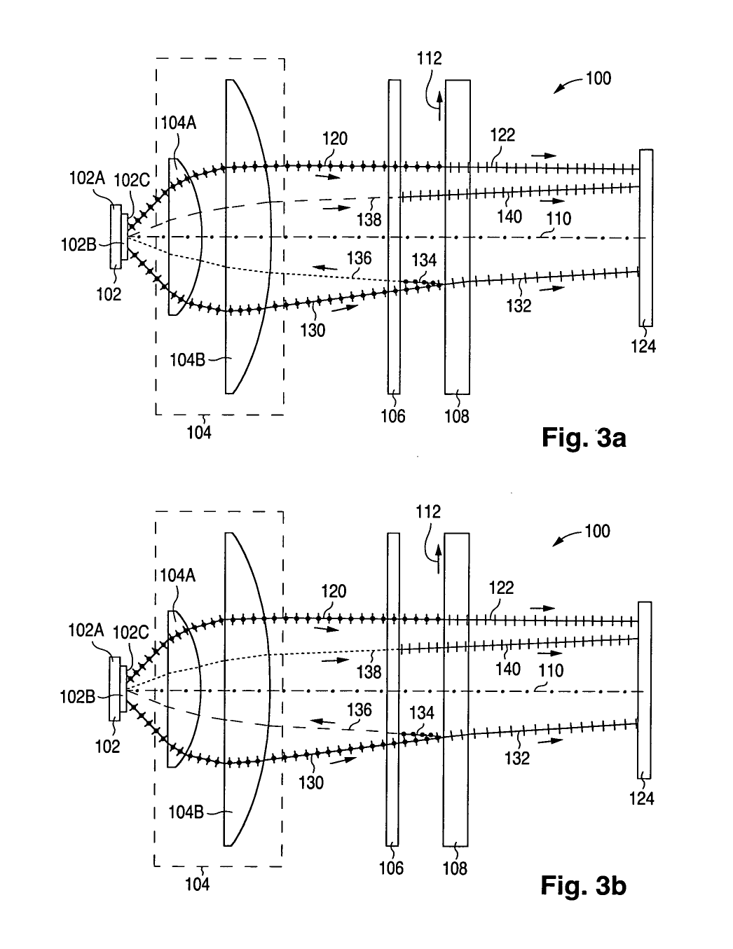

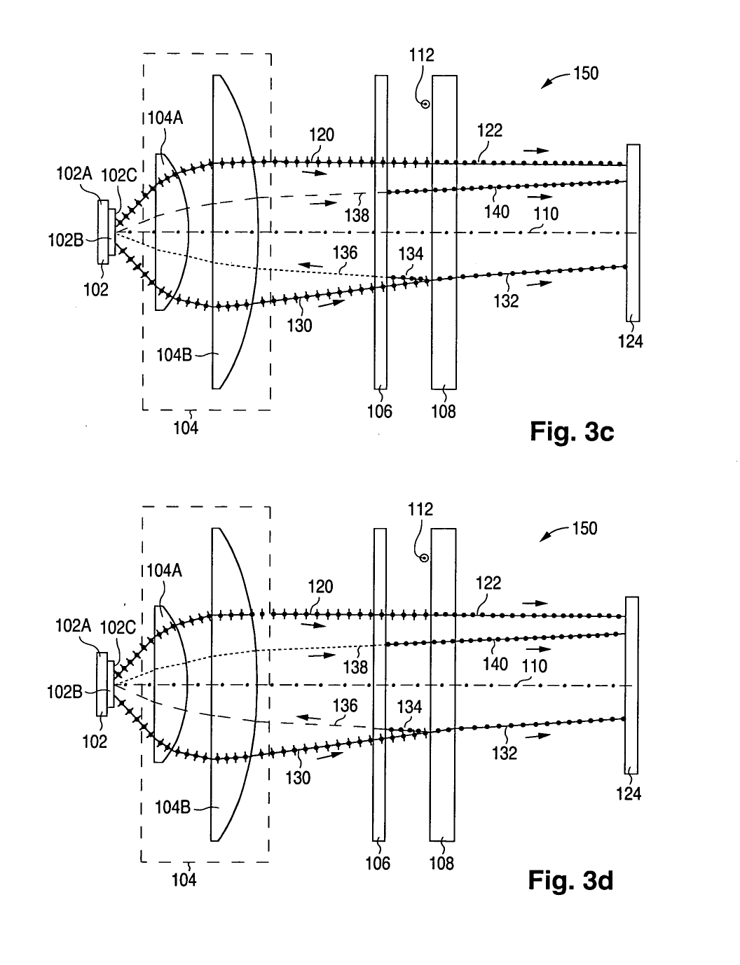

FIG. 3a illustrates a polarization-recovery illumination system 100 configured in accordance with the invention for providing linearly polarized light. Illumination system 100 consists of a light-reflective light source 102, a light collimator 104, a quarter-wave retardation plate 106, and a light-reflective linear polarizer 108 positioned sequentially along a system optical axis 110 as shown in FIG. 3a. In particular, collimator 104 is situated in front of light source 102, retardation plate 106 is situated in front of collimator 104, and polarizer 108 is situated in front of retardation plate 106.

Light source 102, which has high brightness and high luminous output, consists of a substrate 102A and a light emitter 102B having a light-reflective surface 102C which serves as a light reflector. Light emitter 102B, which is mounted on substrate 102A, emits unpolarized visible light that travels away from substrate 102A. Light reflector 102C is mounted on substrate 102A. Light reflector 102C formed by the light-reflective surface of light-emitter 102B reflects light traveling toward light emitter 102B.

The light emitted by light emitter 102B is normally of largely one color. For instance, light emitter 102B may emit red, green, or blue light. So-emitted red light has a wavelength of 600-720 nm, preferably 610-700 nm, more preferably 620-680 nm. So-emitted green light has a wavelength of 500-580 nm, preferably 505-570 nm, more preferably 510-560 nm. So-emitted blue light has a wavelength of 400-495 nm, preferably 430-490 nm, more preferably 445-485 nm.

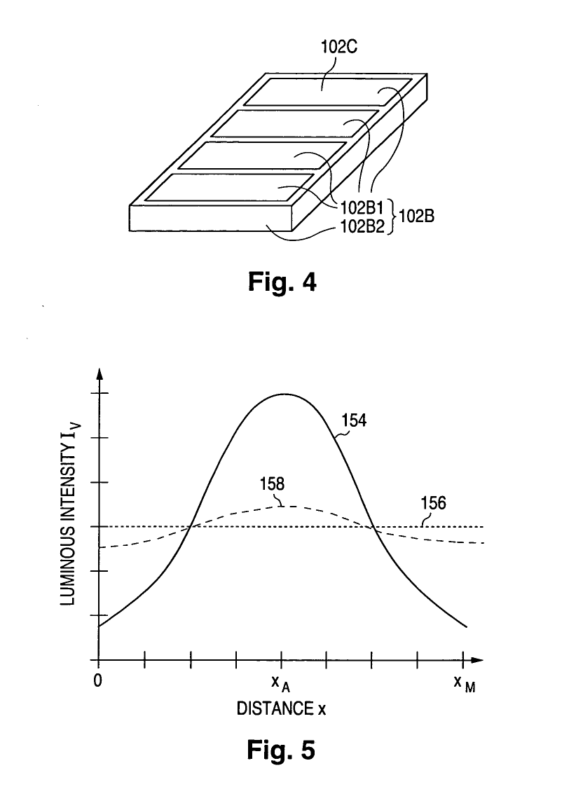

Light source 102 is preferably a light-emitting diode (again “LED”) made by Luminus Devices, Inc. For example, light source 102 may be any one of the three Luminus PhlatLight PT120 LED devices which respectively emit red, green, and blue light. A typical LED implementation of light source 102 is described below in connection with FIG. 4.

When light source 102 is implemented as such an LED, each color of light provided by light emitter 102B is characterized by a center wavelength λ_{c} and a spectrum width 2Δλ_{c} defined as full width at half maximum and centered on center wavelength λ_{c}. That is, the wavelength of the large majority of the rays of each color of light is λ_{c}+Δλ_{c}. Spectrum half width Δλ_{c} is normally no more than 60 nm, preferably no more than 50 nm, typically no more that 40 nm.

Center wavelength λ_{c} for the red light is normally 610-700 nm, preferably 620-680 nm, typically approximately 625 nm. Spectrum half width Δλ_{c} for the red light is typically approximately 20 nm at the typical λ_{c} value of 625 nm. Center wavelength λ_{c} for the green light is normally 505-570 nm, preferably 520-560 nm, typically approximately 530 nm. Spectrum half width Δλ_{c} for the green light is typically approximately 40 nm at the typical λ_{c} value of 530 nm. Center wavelength λ_{c} for the blue light is normally 430-490 nm, preferably 445-485 nm, typically approximately 465 nm. Spectrum half width Δλ_{c} for the blue light is typically approximately 25 nm at the typical λ_{c} value of 465 nm. The fact that the Δλ_{c} spectrum half width values for each of the three colors sometimes take the wavelength outside the maximum λ_{c} center wavelength range for that color is acceptable because the wavelengths of the large majority of light rays of that color fall within its λ_{c} center wavelength range.

Collimator 104 substantially collimates the light emitted by emitter 102B of light source 102. As described below, collimator 104 also collimates light reflected off light reflector 102C. Collimator 104 is formed with one or more collimating lenses. FIG. 3a illustrates an example in which collimator 104 consists of a plano-convex lens 104A and a larger plano-convex lens 104B. The planar side of lens 104A faces light source 102. The planar side of lens 104B faces the convex side of lens 104A so that the convex side of lens 104B faces retardation plate 106.

Quarter-wave retardation plate 106 is oriented substantially perpendicular to optical axis 110. The back and front sides of retardation plate 106 respectively face collimator 104 and polarizer 108 and thus extend laterally substantially perpendicular to optical axis 110. Retardation plate 106 is attuned to the wavelength of the light emitted by light source 102 and consists of birefringement material having fast and slow refraction axes (not shown) along which there are different refractive indices. Suppliers for retardation plate 106 include ColorLink, Inc., and Nitto Optical Co.

Linear polarizer 108 is oriented substantially perpendicular to optical axis 110 and thus laterally substantially parallel to quarter-wave retardation plate 106. The back side of polarizer 108 faces the front side of retardation plate 106. Polarizer 108 has an axis 112 of polarization extending perpendicular to optical axis 110 and parallel to the plane of FIG. 3a. This enables polarizer 108 to transmit visible light whose electric field vector points perpendicular to optical axis 110 and parallel to the (paper) plane of FIG. 3a. In other words, polarizer 108 transmits p linearly polarized light. The back surface of polarizer 108 is light reflective. Polarizer 108 reflects s linearly polarized light whose electric field vector points perpendicular to the plane of FIG. 3a.

Polarization axis 112 is at approximately a 45° angle to the fast refraction axis of quarter-wave retardation plate 106. More specifically, polarization axis 112 is at an angle of approximately −45° or +45° measured counter-clockwise to the retardation plate's fast axis as viewed looking from polarizer 108 toward retardation plate 106 and thus toward light source 102. When polarization axis is at such a −45° angle to the retardation plate's fast axis, backward-traveling s linearly polarized light reflected by polarizer 108 is converted to circularly polarized light of left-handed circular polarization in passing through retardation plate 106. The backward-traveling s linearly polarized light reflected is converted to right-handed circularly polarized light in passing through retardation plate 106 when polarization axis 112 is at a +45° angle measured counter-clockwise to the retardation plate's fast axis as viewed looking from polarizer 108 toward plate 106.

Linear polarizer 108 may be a wire grid of the type made by Moxtek, Inc. Polarizer 108 can also be a reflective cholesteric polarizer or other reflective polarizer.

With the foregoing in mind, illumination system 100 operates as follows in the situation where, as represented by the circular polarization types indicated in FIG. 3a for the implementation of system 100 shown there, polarization axis 112 is at a −45° angle measured counter-clockwise to the fast axis of retardation plate 106 as viewed looking from polarizer 108 toward plate 106. Light source 102 emits unpolarized visible light traveling toward collimator 104. The unpolarized emitted light consists of orthogonal p and s linearly polarized components whose electric field vectors respectively point parallel to and perpendicular to the plane of FIG. 3a.

Collimator 104 collimates the incident unpolarized light into a beam of light traveling substantially parallel to optical axis 110. Item 120 in FIG. 3a indicates one ray of the collimated light beam. As indicated in FIG. 3a, light ray 120 travels substantially parallel to optical axis 110 after passing through collimator 104. The collimated light represented by light ray 120 is transmitted through quarter-wave retardation plate 106 and impinges substantially unchanged on the reflective back surface of polarizer 108.

Upon reaching light-reflective linear polarizer 108, the transmitted beam of collimated light is split into its p and s linearly polarized components. The p linearly polarized component of the transmitted collimated light beam is, neglecting light-absorption loss, largely transmitted through polarizer 108. With light ray 120 being split into a p linearly polarized component and an s linearly polarized component by polarizer 108, item 122 in FIG. 3a represents the ray's p linearly polarized component transmitted through polarizer 108. As indicated by p linearly polarized light ray 122, the p component of the collimated light beam impinges on a target location labeled as item 124 in FIG. 3a. Target location 124 is typically part of a larger target device (not shown). As also indicated by p light ray 122, the p component of the collimated light beam travels substantially parallel to optical axis 110 in impinging on target location 124.

Polarizer 108 largely reflects the s linearly polarized component of the transmitted collimated light beam backward toward quarter-wave retardation plate 106. In traveling backward and later being reflected forward, the s component of the collimated light beam undergoes various transformations and follows largely the same path followed by the light emitted by light source 102 and collimated by collimator 104 into the light beam that passed through retardation plate 106 and impinged on polarizer 108.

It would be difficult for FIG. 3a to illustrate these transformations on the s linearly polarized component of light ray 120 subsequent to being reflected backward by polarizer 108 because the s component of ray 120 follows largely the same path originally followed by full ray 120. Accordingly, the transformations of the s component of the collimated light beam subsequent to being reflected backward by polarizer 108 are illustrated via another light ray 130 which travels in the plane of FIG. 3a significantly non-parallel to optical axis 110 after passing through collimator 104. Light ray 130 passes through retardation plate 106 and impinges on polarizer 108 still traveling significantly non-parallel to optical axis 110. Although FIG. 3a illustrates ray 130 as being emitted by light source 102, ray 130 is not representative of the collimated light beam that arises upon passage through collimator 104. Ray 130 is utilized in FIG. 3a solely to facilitate explanation of the transformations in the collimated light beam subsequent to backward reflection of its s component by polarizer 108.

Subject to the foregoing understanding of light ray 130, polarizer 108 splits ray 130 into a p linearly polarized component 132 and an s linearly polarized component 134. P linearly polarized light ray 132 is then transmitted through polarizer 108 and impinges on target location 124. Polarizer 108 reflects s linearly polarized light ray 134 backward toward retardation plate 106. S linearly polarized light ray 134 travels backward in the plane of FIG. 3a substantially non-parallel to optical axis 110 and substantially non-parallel to the path of forward-traveling incident light ray 130. Since forward-traveling incident light ray 130 also traveled in the plane of FIG. 3a, the plane of FIG. 3a is the incident plane for rays 130 and 134.

The backward-reflected s linearly polarized component of the collimated light beam is largely transmitted through quarter-wave retardation plate 106 and impinges on collimator 104. In passing through retardation plate 106, the backward-reflected s light component is largely converted by retardation plate 106 into circularly polarized light of left-handed circular polarization. The linear-to-circular polarization transformation at plate 106 is represented in FIG. 3a by the conversion of backward-reflected s linearly polarized light ray 134 into a circularly polarized light ray 136 of left-handed circular polarization upon backward passage through plate 106.

The backward-traveling left-handed circularly polarized light largely passes through collimator 104 and is directed by collimator 104 toward light source 102 as shown by backward-traveling left-handed circularly polarized light ray 136 in FIG. 3a. More particularly, collimator 104 focuses the backward-traveling left-handed circularly polarized light on light source 102. A small portion of the backward-traveling left-handed circularly polarized light is invariably absorbed in retardation plate 106 and collimator 104. Importantly, largely all of the backward-traveling left-handed circularly polarized light not absorbed in retardation plate 106 and collimator 104 reaches light source 102.

Upon reaching light source 102, light reflector 102C reflects a large portion of the backward-traveling left-handed circularly polarized light forward toward collimator 104. In being reflected off light reflector 102C, the reflected portion of the backward-traveling left-handed circularly polarized light is converted into circularly polarized light of right-handed circular polarization. The transformation from left-handed circular polarization to right-handed circular polarization during the reflection at light reflector 102C is represented in FIG. 3a by the transformation of backward-traveling circularly polarized light ray 136 of left-handed circular polarization into a forward-traveling light ray 138 of right-handed circular polarization upon reflection at light reflector 102C.

Collimator 104 collimates the recycled forward-traveling right-handed circularly polarized light into a beam of right-handed circularly polarized light traveling substantially parallel to optical axis 110 toward quarter-wave retardation plate 106. In FIG. 3a, forward-traveling right-handed circularly polarized light ray 138 passes through collimator 104 and impinges on retardation plate 106. Because light ray 130 was, for illustrative purposes, depicted as traveling significantly non-parallel to optical axis 110, light ray 138 travels significantly non-parallel to optical axis 110 upon passage through collimator 104.

The recycled beam of forward-traveling right-handed circularly polarized light is largely transmitted by quarter-wave retardation plate 106 and impinges on linear polarizer 108. In largely passing through retardation plate 106, the beam of forward-traveling right-handed circularly polarized light is largely converted into a beam of p linearly polarized light still traveling substantially parallel to optical axis 110. The circular-to-linear polarization transformation at plate 106 is represented in FIG. 3a by the conversion of forward-traveling light ray 138 of right-handed circular polarization into a p linearly polarized light ray 140 upon passage through plate 106.

The recycled beam of p linearly polarized light impinges on target location 124 still traveling substantially parallel to optical axis 110. Since the p linearly polarized component of the original collimated beam of unpolarized light emitted by light source 102 impinged on target location 124 traveling substantially parallel to optical axis 110, illumination system 100 converts considerably more than half of the light of the original collimated beam of unpolarized light into p linearly polarized light traveling substantially parallel to optical axis 110. Importantly, the recycling action of illumination system 100 does not increase the system étendue.

Subject to reversal of the circular polarization types, illumination system 100 operates the same when polarization axis 112 is at a +45° angle measured counter-clockwise to the fast diffraction axis of retardation plate 106 as viewed looking from polarizer 108 toward quarter-wav retardation plate 106. FIG. 3b depicts such an implementation of illumination system 100. Light rays 136 and 138 in FIG. 3c have the same meaning as in FIG. 3a except that the handednesses of their circular polarizations are reversed. The s light component reflected backward by polarizer 108 is thus largely converted to backward-traveling right-handed circularly polarized light in passing backward through retardation plate 106. At reflector 102C, reflection of incident backward-traveling right-handed circularly polarized light largely converts it into forward-traveling left-handed circularly polarized light. Retardation plate 106 then largely converts forward-traveling left-handed circularly polarized into p linearly polarized light that largely passes through polarizer 108 to complete the polarization recovery.

FIG. 3c illustrates another polarization-recovery illumination system 150 configured in accordance with the invention. Illumination system 100 consists of light-reflective light source 102, light collimator 104, quarter-wave retardation plate 106, and light-reflective linear polarizer 108 all configured and operable the same as in illumination system 100 except that polarization axis 112 of polarizer 108 in illumination system 150 extends perpendicular to the plane of the figure rather than parallel to the plane of the figure as occurs with polarizer 108 in illumination system 100. Accordingly, polarizer 108 in illumination system 150 largely transmits s linearly polarized light whose electric field vector points perpendicular to the plane of FIG. 3c. Polarizer 108 in illumination system 150 then largely reflects p linearly polarized light whose electric field vector points parallel to the plane of FIG. 3c.

Illumination system 150 can essentially be illumination system 100 as seen in FIG. 3c upon rotating illumination system 100 by a quarter turn (90°) about optical axis 110. In any event, all the comments made above about illumination system 100 apply to illumination system 150 subject to changing p linearly polarized light to s linearly polarized light and vice versa. Hence, polarizer 108 in illumination system 150 largely transmits the s linearly polarized component of the original collimated light beam, again neglecting light-absorption loss, and largely reflects its p linearly polarized component backward toward quarter-wave retardation plate 106.

Light rays 122, 132, and 140 in FIG. 3c have the same meaning as in FIG. 3a except that their various p and s linear polarization types are reversed. In the situation where, as represented by the circular polarization types indicated in FIG. 3c for the implementation of illumination system 100 shown there, polarization axis 112 is at a −45° angle measured counter-clockwise to the retardation plate's fast axis as viewed looking from polarizer 108 toward plate 106, the backward-reflected p linearly polarized light component in system 150 is largely converted into left-handed circularly polarized light upon passage through quarter-wave retardation plate 106.

After the backward-traveling left-handed circularly polarized light is directed by collimator 104 to light source 102, a large portion of the backward-traveling left-handed circularly polarized light is reflected forward by light reflector 102C and converted into right-handed circularly polarized light that is collimated by collimator to produce a beam of right-handed circularly polarized light traveling forward toward quarter-wave retardation plate 106 substantially parallel to optical axis 110. Retardation plate 106 largely transmits the beam of right-handed circularly polarized light and converts it into s linearly polarized light that largely passes through polarizer 108 and impinges on target location 124 substantially parallel to optical axis 110.

Illumination system 150 operates the same when polarization axis 112 is at a +45° angle measured counter-clockwise to the fast diffraction axis of retardation plate 106 as viewed looking from polarizer 108 toward plate 106 except that the circular polarization types are reversed. FIG. 3d depicts such an implementation of illumination system 150. Light rays 136 and 138 in FIG. 3d have the same meaning as in FIG. 3c except for reversal of the handednesses of their circular polarizations. Hence, the p light component reflected backward by polarizer 108 is largely converted to backward-traveling right-handed circularly polarized light in passing backward through retardation plate 106. At reflector 102C, reflection of incident backward-traveling right-handed circularly polarized light largely converts it into forward-traveling left-handed circularly polarized light. Retardation plate 106 then largely converts forward-traveling left-handed circularly polarized into s linearly polarized light that largely passes through polarizer 108 to complete the polarization recovery.

A more detailed view of the core of light source 102 as implemented with an LED such as any of the three Luminus PhlatLight PT120 LED devices is presented in FIG. 4. Light emitter 102B here consists of a group of metallic first electrodes 102B1 and a metallic second electrode 102B2 that laterally surrounds each first electrode 102B1. First electrodes 102B1 emit unpolarized light of a selected color, e.g., red, green, or blue. The upper surfaces of first electrodes 102B1 are light reflective and serve at least partially as light reflector 102C. The upper surface of second electrode 102B2 may be light reflective. If so, they also serve as part of light reflector 102C.

FIG. 5 illustrates how the luminous intensity I_{V} of the linearly polarized light provided by illumination system 100 or 150 typically varies across target location 124 as a function of distance x measured from one end of target location 124, e.g., the lower end in FIG. 3a or 3b, along a line extending through optical axis 110. Distance value x_{M} indicates the opposite end of target location 124. Distance value x_{A}, which approximately equals x_{M}/2, indicates the location of optical axis 110.

Curve 154 in FIG. 5 specifically depicts how luminous intensity I_{V} varies across target location 124 for a typical implementation of illumination system 100 or 150, including a typical implementation of light source 102 as a light-reflective LED. As curve 154 shows, luminous intensity I_{V} varies across target location 124 in a roughly Gaussian manner and reaches a peak value at the place where optical axis 110 intersects target location 124. Luminous intensity I_{V} is normally considerably higher at the place where optical axis 110 intersects target location 124 than at the ends of target location 124 along the line extending through optical axis 110. The I_{V} variation exemplified by curve 154 is acceptable in some illumination applications that use linearly polarized light.

Other illumination applications using linearly polarized light require that the I_{V} intensity across target location 124 be much more uniform that that exemplified by curve 154. Luminous intensity I_{V} in many of these other illumination applications should ideally be substantially constant across target location 124 indicated by dotted-line curve 156 in FIG. 5. However, many of these other illumination applications can accept an IV variation in which luminous intensity I_{V} is no more than 25% higher, preferably no more than 20% higher, more preferably no more than 15% higher, where optical axis 110 intersects target location 124 than at the ends of target location 124 along the line extending through optical axis 110. Dashed-line curve 158 in FIG. 5 exemplifies such a tolerable I_{V} variation.

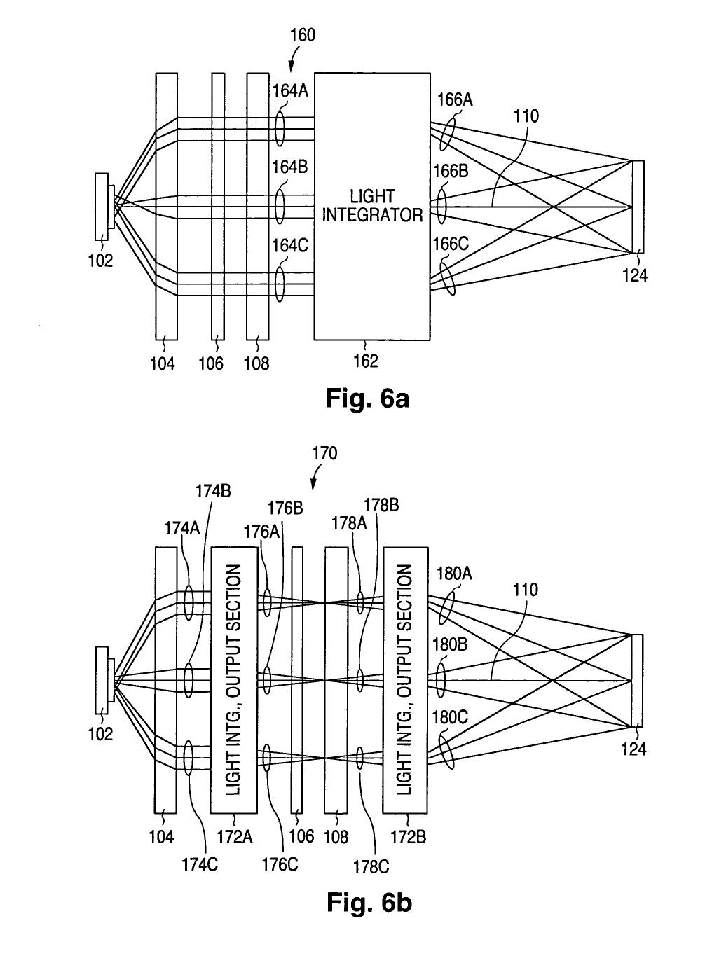

FIG. 6a illustrates an extension 160, configured in accordance with the invention, of polarization-recovery illumination system 100 or 150 to include a light integrator 162 for causing the linearly polarized light provided by components 102, 104, 106, and 108 to be mixed in such a way as to produce integrated linearly polarized light of more uniform illumination, i.e., less I_{V} variation, than the linearly polarized light provided by system 100 or 150. Subject to the presence of light integrator 162, components 102, 104, 106, and 108 of polarization-recovery illumination system 160 are arranged sequentially the same as in illumination system 100 or 150. Integrator 162 is situated between polarizer 108 and target location 124.

The light which is collimated by collimator 104 in polarization-recovery illumination system 160 and which is then transmitted through quarter-wave retardation plate 106 and linear polarizer 108 includes a plurality of partial fluxes of linearly polarized light of either p or s linear polarization type depending on the orientation of polarizer 108. Three such partial light fluxes 164A, 164B, and 164C (collectively “164”) of linearly polarized light are shown in FIG. 6a. Partial light fluxes 164 are referred to here as parallel fluxes because their light rays all travel substantially parallel to one another and to optical axis 110. One of the light rays of parallel partial flux 164B travels substantially along optical axis 110.

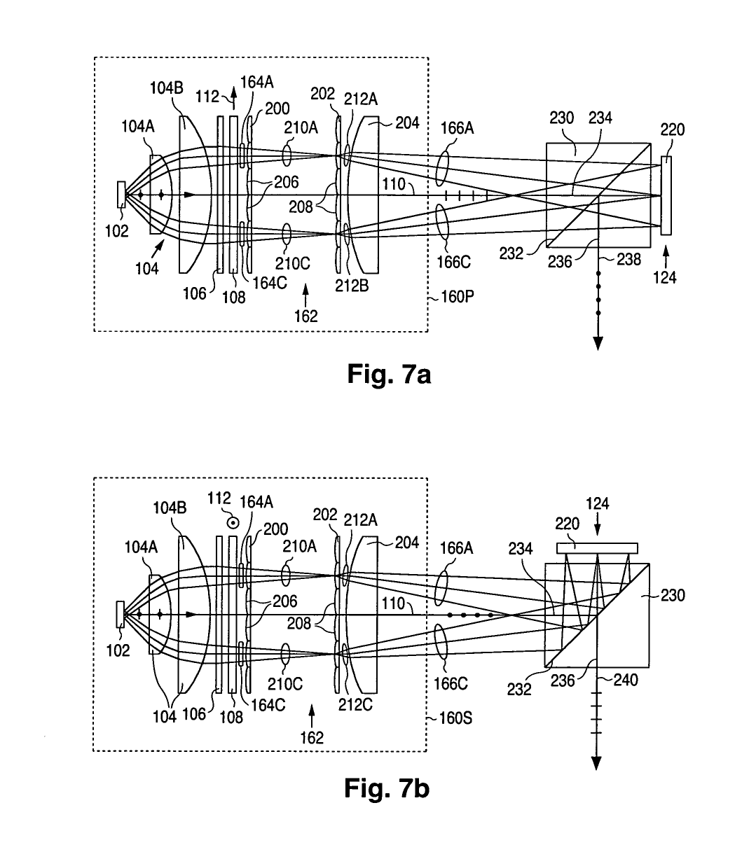

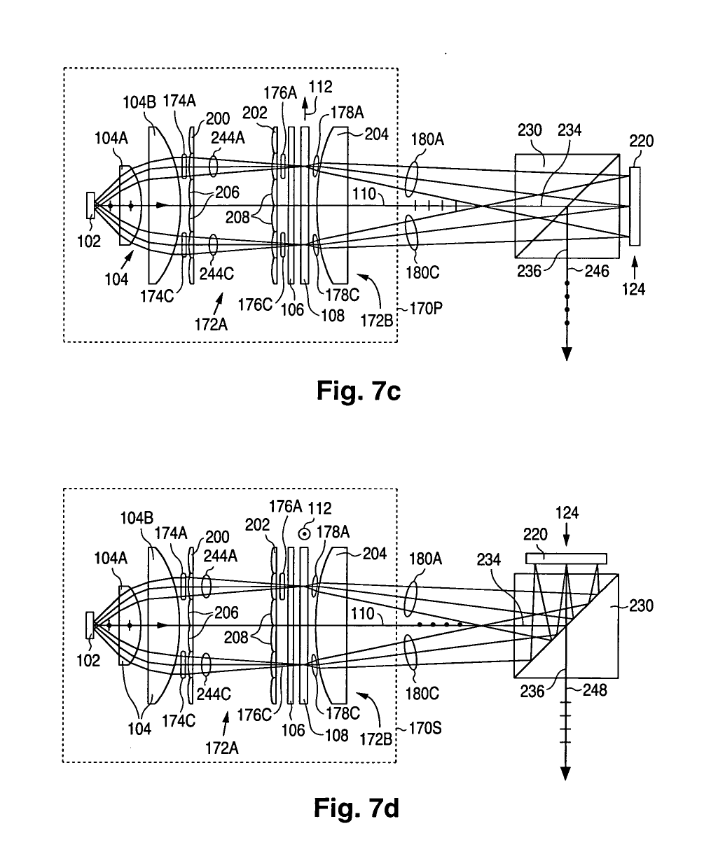

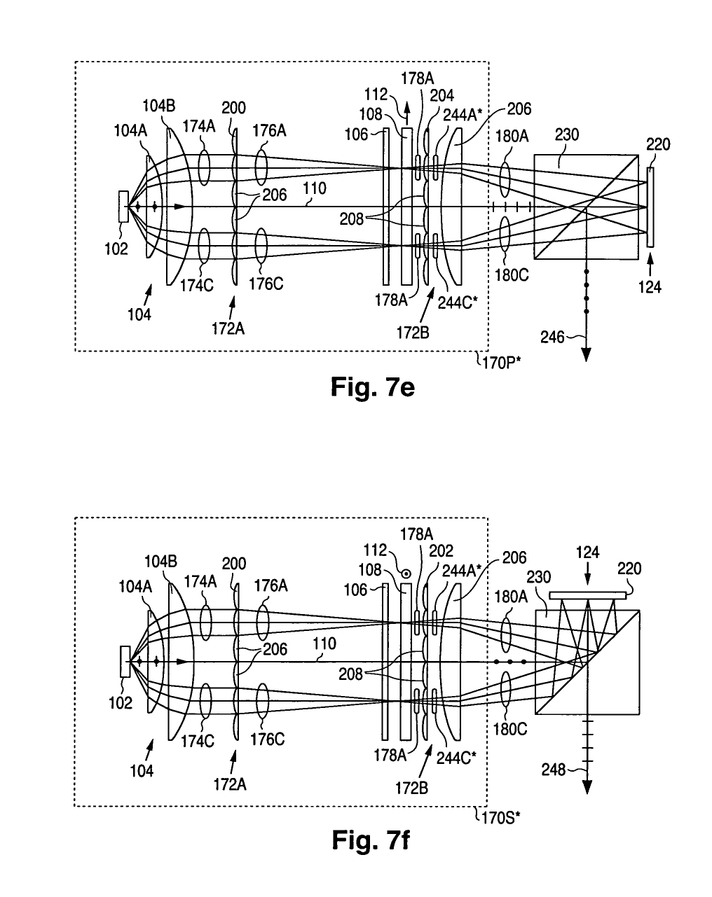

Light integrator 162 converts light of each parallel partial flux 164 of linearly polarized light into a corresponding divergent partial flux of linearly polarized light of the same linear polarization type as that parallel flux 164. FIG. 6a shows three such divergent partial light fluxes 166A, 166B, and 166C (collectively “166”) respectively produced from parallel fluxes 164A, 164B, and 164C. In the process of converting light of parallel fluxes 164 into divergent fluxes 166, integrator 162 typically initially converts light of each parallel flux 164 into a convergent flux (not shown in FIG. 6a) of linearly polarized light. Integrator 162 then converts light of the convergent fluxes into divergent fluxes 166. Two examples of this internal process of integrator 162 are described below in connection with FIGS. 7a and 7b.

In any event, integrator 162 directs each divergent flux 166 of linearly polarized light toward target location 124 so as to be distributed across largely the entire area of target location 124. Divergent fluxes 166 thereby mix with one another at target location 124. As a result, the linearly polarized light at target location 124 is of more uniform illumination than the linearly polarized light which, in the absence of integrator 162, would be provided by components 102, 104, 106, and 108 at target location 124.

FIG. 6b illustrates another extension 170, configured in accordance with the invention, of polarization-recovery illumination system 100 or 150 to include a light integrator 172 for causing the linearly polarized light provided by components 102, 104, 106, and 108 to be mixed in such a way as to produce integrated linearly polarized light of more uniform illumination than the linearly polarized light provided by system 100 or 150. Subject to the presence of light integrator 172, components 102, 104, 106, and 108 of polarization-recovery illumination system 170 are arranged sequentially the same as in illumination system 100 or 150. Integrator 172 consists of an input section 172A and an output section 172B. Integrator input section 172A is situated between collimator 104 and quarter-wave retardation plate 106. Integrator output section 172B is situated between polarizer 108 and target location 124.

The light collimated by collimator 104 in polarization-recovery illumination system 170 includes a plurality of partial fluxes of collimated light. Three such partial light fluxes 174A, 174B, and 174C (collectively “174”) of collimated light are shown in FIG. 6b. Partial light fluxes 174 are referred to here as parallel fluxes because their light rays all travel substantially parallel to one another and to optical axis 110. Due to the above-described actions of components 102, 106, and 108, the collimated light of parallel partial fluxes 174 consists of both unpolarized light and circularly polarized light. The circularly polarized light of partial parallel fluxes 174 is (i) of right-handed circular polarization when polarization axis 112 is at a −45° angle measured counter-clockwise to the fast axis of retardation plate 106 as viewed looking from polarizer 108 toward plate 106 as arises in illumination system 110 of FIG. 3a or illumination system 150 of FIG. 3c and (ii) of left-handed circular polarization when polarization axis 112 is at a −45° angle to the fast axis of retardation plate 106 measured the same way as arises in illumination system 110 of FIG. 3b or illumination system 150 of FIG. 3d. One of the light rays of parallel partial flux 174B travels substantially along optical axis 110.

Input section 172A of light integrator 172 converts light of each parallel partial flux 174 of collimated light into a corresponding convergent partial flux of unpolarized and circularly polarized light. FIG. 6b shows three such convergent partial light fluxes 176A, 176B, and 176C (collectively “176”) respectively produced from parallel fluxes 174A, 174B, and 174C. Although the light rays of each convergent partial flux 176 converge, their light rays travel as a group substantially parallel to optical axis 110. The handedness of the circularly polarized light of convergent partial fluxes 176 is the same as the handedness of the circularly polarized light of parallel partial fluxes 174.

The light-directing properties of integrator input section 172A are preferably chosen such that, subject to taking the light-refractive characteristics of quarter-wave retardation plate 106 and polarizer 108 into account, the focal point of each convergent light flux 176 is very close to the back surface of polarizer 108. That is, the light rays of each convergent flux 176 reach maximum convergence very close to the back side of polarizer 108. Choosing the light-directing properties of integrator input section 172A in this way enables a very high percentage of the light reflected backward by polarizer 108 to be directed by collimator 104 toward light reflector 102C of light source 102 during the polarization recovery process.

Light of convergent fluxes 176 is transmitted through quarter-wave retardation plate 106. In so doing, retardation plate 106 operates on convergent light fluxes 176 in the same way as described above in connection with light rays 120, 130, and 138 in illumination system 100 or 150. In particular, unpolarized light of convergent fluxes 176 simply largely passes through plate 106. Circularly polarized light of convergent fluxes 176 largely passes through plate 106 and, in so doing, is converted into linearly polarized light of p or s linear polarization depending on the orientation of polarizer 108.

The p or s linearly polarized light of convergent fluxes 176 largely passes through polarizer 108 and impinges on output section 172B of light integrator 172. Depending on the orientation of polarizer 108, the p or s linearly polarized component of the unpolarized light of convergent fluxes 176 is largely transmitted through polarizer 108 and impinges on integrator output section 172B. Polarizer 108 largely reflects the other linearly polarized component, i.e., the s or p component, of the unpolarized light of convergent fluxes 176 backward toward quarter-wave retardation plate 106. This backward-reflected light is not separately indicated in FIG. 6b.

Due to the action of retardation plate 106 and polarizer 108, the light transmitted through polarizer 108 consists only of linearly polarized light of p or s linear polarization type. In addition, the portions of convergent light fluxes 176 transmitted through polarizer 108 are respectively converted into divergent partial light fluxes because the focal points of convergent fluxes 176 are very close to the back surface of polarizer 108. Three such primary divergent partial fluxes 178A, 178B, and 178C (collectively “178”) of linearly polarized light are shown in FIG. 6b. Although the light rays of each primary divergent partial flux 178 diverge, their light rays travel as a group substantially parallel to optical axis 110.

Output section 172B of light integrator 172 converts light of each primary divergent flux 178 of linearly polarized light into a corresponding further divergent partial flux of linearly polarized light of the same linear polarization type as that primary divergent flux 178. FIG. 6b shows three such further divergent partial light fluxes 180A, 180B, and 180C (collectively “180”) respectively produced from primary divergent fluxes 178A, 178B, and 178C. Integrator output section 172B directs each further divergent partial flux 180 of linearly polarized light toward target location 124 so as to be distributed across largely the entire area of target location 124. Consequently, further divergent fluxes 180 mix with one another at target location 124. The linearly polarized light at target location 124 is therefore of more uniform illumination than the linearly polarized light which, in the absence of integrator 172, would be provided by components 102, 104, 106, and 108 at target location 124.

FIG. 7a illustrates an optical assembly that contains an implementation 160P of polarization-recovery illumination system 160 in which polarization axis 112 of polarizer 108 extends parallel to the plane of the figure as in illumination system 100 of FIG. 3a. Light integrator 162 in polarization-recovery illumination system 160P consists of a first lens array 200 and a lensing arrangement formed with a second lens array 202 and a plano-convex focusing lens 204. First lens array 200, second lens array 202, and focusing lens 204 are arranged sequentially along optical axis 110. More particularly, first lens array 200 is situated in front of polarizer 108, second lens array 202 is situated in front of first lens array 200, and focusing lens 204 is situated in front of second lens array 202.

First lens array 200 is formed with a plurality of largely identical plano-convex lenses 206 arranged in a two-dimensional array. The convex sides of plano-convex lenses 206 are all on the same side of lens array 200. This side of lens array 200 is referred to as its convex side. The convex side of first lens array 200 faces polarizer 108. The other side of first lens array 200, along which the planar sides of lenses 206 are located, is referred to as its planar side.

Second lens array 202 is formed with a plurality of largely identical plano-convex lenses 208 arranged in a two-dimensional array. The convex sides of plano-convex lenses 208 are all on the same side of lens array 202. This side of lens array 202 is referred to as its convex side. The convex side of second lens array 202 faces the planar side of first lens array 200. The other side of second lens array 202, along which the planar sides of lenses 208 are located, is referred to as its planar side. The planar side of second lens array 202 faces the convex side of focusing lens 204. The planar side of focusing lens 204 then faces target location 124.

The number of lenses 208 in second lens array 202 is the same as the number of lenses 206 in first lens array 200. The arrangement of the array of lenses 208 in second lens array 202 is identical to the arrangement of the array of lenses 206 in first lens array 200. Each lens 208 in second lens array 202 is situated substantially opposite a corresponding different one of lenses 206 in first lens array 200. In particular, the convex side of each lens 208 in second lens array 202 is situated substantially opposite the planar side of corresponding lens 206 in first lens array 200.

The planar side of second lens array 202 can alternatively face the planar side of first lens array 200. In that case, the convex side of second lens array 202 faces the convex side of focusing lens 204. The planar side of each lens 208 in second lens array 202 is then situated substantially opposite the planar side of corresponding lens 206 in first lens array 200.

In examining the operation of light integrator 162 of illumination system 160P, note that only exemplary parallel partial light fluxes 164A and 164C appear in FIG. 7a. Also, only exemplary divergent light fluxes 166A and 166C appear in FIG. 7a. Parallel fluxes 164 and divergent fluxes 166 consist of p linearly polarized light in FIG. 7a because polarizer 108 transmits p linearly polarized light in system 160P.

Parallel partial light fluxes 164 are respectively provided to lenses 206 of first lens array 200. Each lens 206 transmits light of its parallel flux 164 and causes that light to converge into a convergent partial flux of p linearly polarized light. Two such convergent partial fluxes 210A and 210C (collectively “210”) of p linearly polarized light are shown in FIG. 7a. Although the light rays of each convergent partial flux 210 converge, their light rays travel as a group substantially parallel to optical axis 110. Each convergent flux 210 normally reaches maximum convergence at approximately the center of the convex side of oppositely situated lens 208 of second lens array 202.

Each lens 208 transmits light of its incident convergent flux 210 to produce a corresponding divergent partial flux of p linearly polarized light. FIG. 7a shows two such divergent partial fluxes 212A and 212C (collectively “212”) of p linearly polarized light. Although the light rays of each divergent partial flux 212 diverge, their light rays travel as a group substantially parallel to optical axis 110. Divergent light fluxes 212 pass largely through focusing lens 204 to become divergent light fluxes 166 that are directed by it to mix at target location 124.

Target location 124 in the optical assembly of FIG. 7a is a reflective LCD panel 220. In traveling to reflective LCD panel 220 after passing through focusing lens 204, the p linearly polarized light of divergent fluxes 166 largely passes through a light-directing structure formed with a polarization beam splitter (again “PBS”) 230 having a beam-splitting plate 232 situated at approximately a 45° angle to optical axis 110. PBS 230 has a first optical axis 234 and a second optical axis 236 extending perpendicular to first optical axis 234. First PBS optical axis 234 is substantially coincident with optical axis 110 of illumination system 160P and substantially perpendicular to the target area of LCD panel 220.

LCD panel 220 modulates the incident p linearly polarized light of divergent fluxes 166 and reflects part of that light back as a modulated beam 238 of s linearly polarized light. Beam-splitting plate 232 largely reflects modulated s linearly polarized light beam 238 so that it makes a bend of roughly 90°. Modulated light beam 238 then travels generally along second PBS optical axis 236 to a screen (not shown) which displays an image corresponding to the modulation by LCD panel 220. Due to the light mixing action of integrator 162, the illumination of the image on the screen is quite uniform.

FIG. 7b illustrates an optical assembly that contains an implementation 160S of polarization-recovery illumination system 160 in which polarization axis 112 of polarizer 108 extends perpendicular to the plane of the figure as in illumination system 150 of FIG. 3c. Light integrator 162 in polarization-recovery illumination system 160S consists of lens arrays 200 and 202 and focusing lens 204 arranged the same as in illumination system 160P.

Light integrator 162 in illumination system 160P operates the same as in illumination system 160S except that parallel partial light fluxes 164 and divergent light fluxes 166 consist of s linearly polarized light in FIG. 7b because polarizer 108 transmits s linearly polarized light in system 160S instead of p linearly polarized light as occurs in system 160S. Accordingly, convergent light fluxes 210 and divergent light fluxes 212 in light integrator 162 consist of s linearly polarized light in system 160S.

Reflective LCD panel 220, which is accessed through a light-directing structure formed with PBS 230, constitutes target location 124 in the optical assembly of FIG. 7b. Instead of being substantially perpendicular to first PBS optical axis 234, the target area of LCD panel 220 is substantially perpendicular to second PBS optical axis 236 in the optical assembly of FIG. 7b. The s linearly polarized light of divergent fluxes 166 largely reflects off beam-splitting plate 232 of PBS 230 in the assembly of FIG. 7b, making a bend of roughly 90°, and then travels to LCD panel 220.

LCD panel 220 modulates the incident s linearly polarized light of divergent fluxes 180 and reflects part of that light back as a modulated beam 240 of p linearly polarized light. Modulated p linearly polarized light beam 240 largely passes through PBS 230 and impinges generally along second optical axis 236 onto a screen (not shown) which displays an image corresponding to the LCD panel modulation. As in the optical assembly of FIG. 7a, the light mixing action of integrator 162 causes the illumination of the image on the screen to be quite uniform in the optical assembly of FIG. 7b.

FIG. 7c illustrates an optical assembly that contains an implementation 170P of polarization-recovery illumination system 170 in which polarization axis 112 of polarizer 108 extends parallel to the plane of the figure as in illumination system 100 of FIG. 3a. Input section 172A of light integrator 172 in polarization-recovery illumination system 170P consists of lens arrays 200 and 202 arranged sequentially along optical axis 110. The convex side of first lens array 200 faces collimator 104. The convex side of second lens array 202 faces the planar side of first lens array 200. The planar side of second lens array 202 faces quarter-wave retardation plate 106. Output section 172B of integrator 172 in system 170P consists of focusing lens 204 arranged so that its convex and planar sides respectively face polarizer 108 and target location 124.

In examining the operation of light integrator 172 in illumination system 170P, note that only exemplary parallel partial light fluxes 174A and 174C appear in FIG. 7c. Also, only exemplary convergent light fluxes 176A and 176C, their exemplary partner primary divergent light fluxes 178A and 178C, and their exemplary partner further divergent light fluxes 180A and 180C appear in FIG. 7c. Primary divergent fluxes 178 and further divergent fluxes 180 consist of p linearly polarized light because polarizer 108 transmits p linearly polarized light in system 170P.

Parallel partial light fluxes 174 are respectively provided to lenses 206 of first lens array 200 in input integrator section 172A. Each lens 206 transmits light of its parallel light flux 174 and causes that light to converge into a convergent partial flux of unpolarized and circularly polarized light. Two such convergent partial fluxes 244A and 244C (collectively “244”) of unpolarized and circularly polarized light are shown in FIG. 7c. The handedness of the circularly polarized light of convergent partial fluxes 244 is the same as that of the circularly polarized light of parallel partial fluxes 174. Although the light rays of each convergent flux 244 converge, their light rays travel as a group substantially parallel to optical axis 110.

Convergent light fluxes 244 respectively impinge on lenses 208 of second lens array 202. Each lens 208 transmits light of its incident convergent light flux 244 to produce a corresponding one of convergent fluxes 176 of unpolarized and circularly polarized light.

Quarter-wave retardation plate 106 and polarizer 108 operate on convergent light fluxes 176 in the manner described in connection with FIG. 6b to produce primary divergent light fluxes 178 of linearly polarized light. The linearly polarized light of primary divergent fluxes 178 is of p linear polarization type due to the orientation of polarizer 108 here. Primary divergent light fluxes 178 pass largely through focusing lens 204 of output integrator section 172B to respectively become further divergent light fluxes 180 that are directed by focusing lens 204 to mix at target location 124.

Reflective LCD panel 220 serves as target location 124 in the optical assembly of FIG. 7c. In traveling to reflective LCD panel 220, the p linearly polarized light of further divergent fluxes 180 largely passes through a light-directing structure constituted with PBS 230. First PBS optical axis 234 is substantially coincident with optical axis 110 of illumination system 170P and substantially perpendicular to the LCD panel target area.

Similar to the optical assembly of FIG. 7a, LCD panel 220 in the optical assembly of FIG. 7c modulates the incident p linearly polarized light of divergent fluxes 180 and reflects part of that light back as a beam 246 of s linearly polarized light. Beam-splitting plate 232 largely reflects s linearly polarized light beam 246 so that it makes roughly a 90° bend. This causes light beam 246 to travel generally along second PBS optical axis 236 to a screen (again not shown) which displays an image corresponding to the LCD panel modulation. The illumination of the image on the screen is quite uniform due to the light mixing action of integrator 172.

FIG. 7d illustrates an optical assembly that contains an implementation 170S of polarization-recovery illumination system 170 in which polarization axis 112 of polarizer 108 extends perpendicular to the plane of the figure as in illumination system 150 of FIG. 3c. Input section 172A of light integrator 172 in polarization-recovery illumination system 170S consists of lens arrays 200 and 202 arranged the same as in illumination system 170P. Output section 172B of integrator 172 in system 170P consists of focusing lens 204 arranged the same as in system 170P.

Light integrator 172 in illumination system 170P operates the same as in illumination system 170S except that divergent light fluxes 178 and 180 consist of s linearly polarized light in FIG. 7d because polarizer 108 transmits s linearly polarized light in system 170S rather than p linearly polarized light as occurs in system 170P.

Target location 124 in the optical assembly of FIG. 7d is reflective LCD panel 220 again accessed via a light-directing structure constituted with PBS 230. Rather than being substantially perpendicular to first PBS optical axis 234, the LCD panel target area of LCD is substantially perpendicular to second optical axis 236 of PBS 230 in the optical assembly of FIG. 7d. The s linearly polarized light of further divergent fluxes 180 largely reflects off beam-splitting plate 232 of PBS 230 in the optical assembly of FIG. 7d, making roughly a 90° bend, and then travels to LCD panel 220.

Similar to the optical assembly of FIG. 7b, LCD panel 220 in the optical assembly of FIG. 7d modulates the incident s linearly polarized light of divergent fluxes 180 and reflects part of that light back as a beam 248 of p linearly polarized light that largely passes through PBS 230 and impinges generally along second PBS optical axis 236 onto a screen (not shown) which display an image corresponding to the LCD panel modulation. The light mixing action of integrator 172 causes the illumination of the image on the screen to be quite uniform.

FIG. 7e illustrates a variation 170P* of polarization-recovery illumination system 170P in which input section 172A of light integrator 172 consists only of first lens array 200. FIG. 7f depicts a similar variation 170S* of polarization-recovery illumination system 170S in which input integrator section is formed only with lens array 200. The convex side of lens array 200 again faces collimator 104 in each of polarization-recovery illumination systems 170P* and 170S*. The planar side of lens array 200 now faces quarter-wave retardation plate 106. Lens array 200 then directly converts parallel light fluxes 174 into convergent light fluxes 176 that impinge on quarter-wave retardation plate 106.

In each of illumination systems 170P* and 170S*, output section 172B of light integrator 172 consists of second lens array 202 and focusing lens 204. Second lens array 202 is situated between polarizer 108 and focusing lens 204. In particular, the convex side of lens array 202 faces polarizer 108. The planar side of lens array 202 faces the convex side of focusing lens 204 whose planar side again faces target location 124.

Primary divergent light fluxes 178 of p or s linearly polarized light impinge respectively on lenses 208 of lens array 202 in each of illumination systems 170P* and 170S*. Each lens 208 transmits light of its primary divergent light flux 178 to produce an additional partial flux of transmitted p or s linearly polarized light which can be divergent or convergent. Two such partial fluxes 244A* and 244C* (collectively “244”) of p or s linearly polarized light are shown in each of FIGS. 7e and 7f. Additional light fluxes 244* are illustrated as being divergent in the examples of FIGS. 7e and 7f. Light of additional light fluxes 244* is then transmitted through focusing lens 204 to become divergent light fluxes 180 that are directed by focusing lens 204 to mix at target location 124.

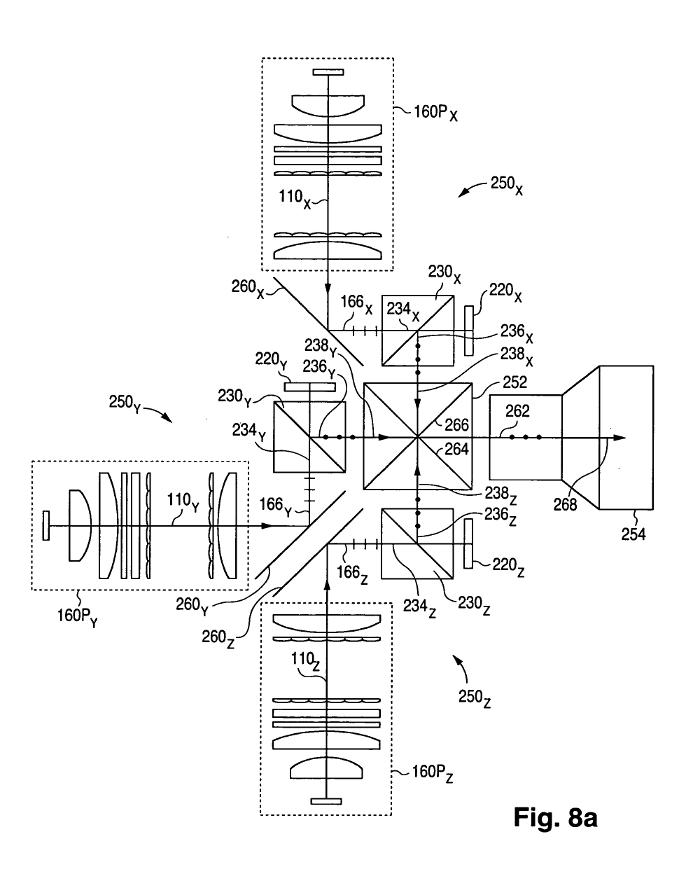

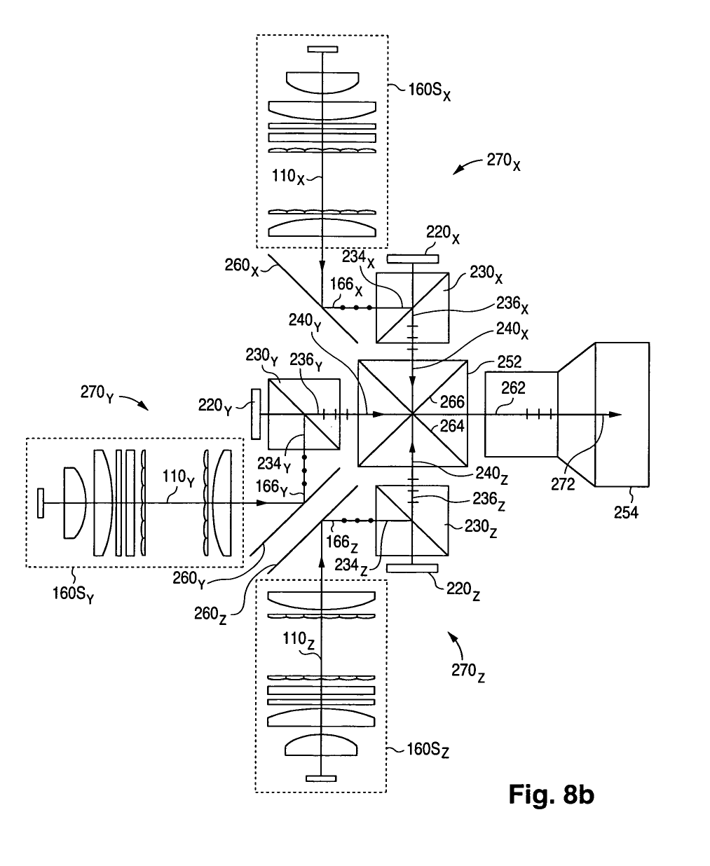

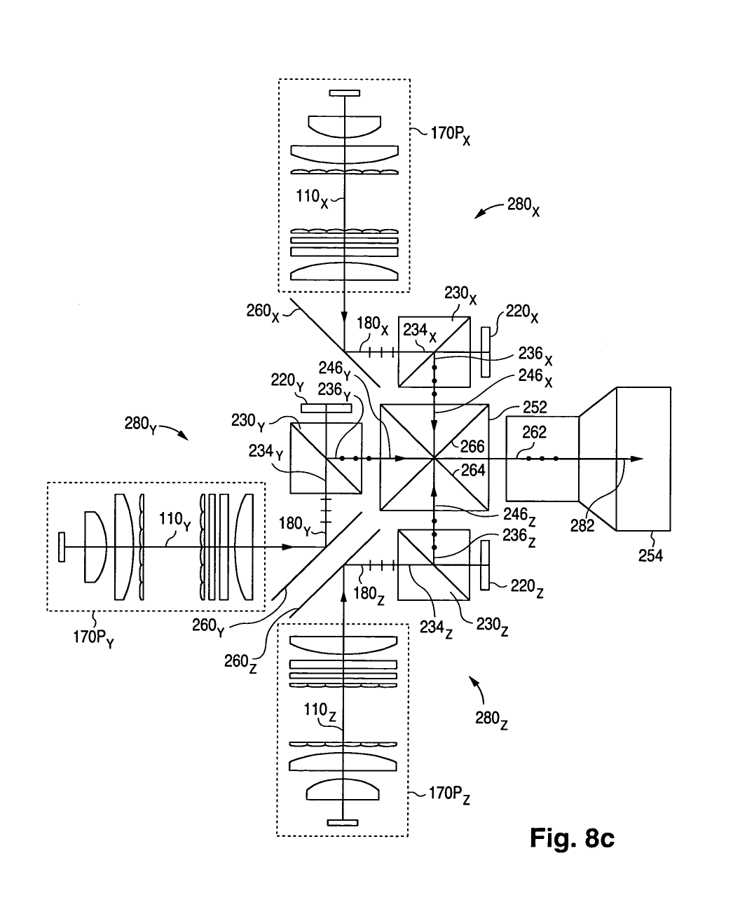

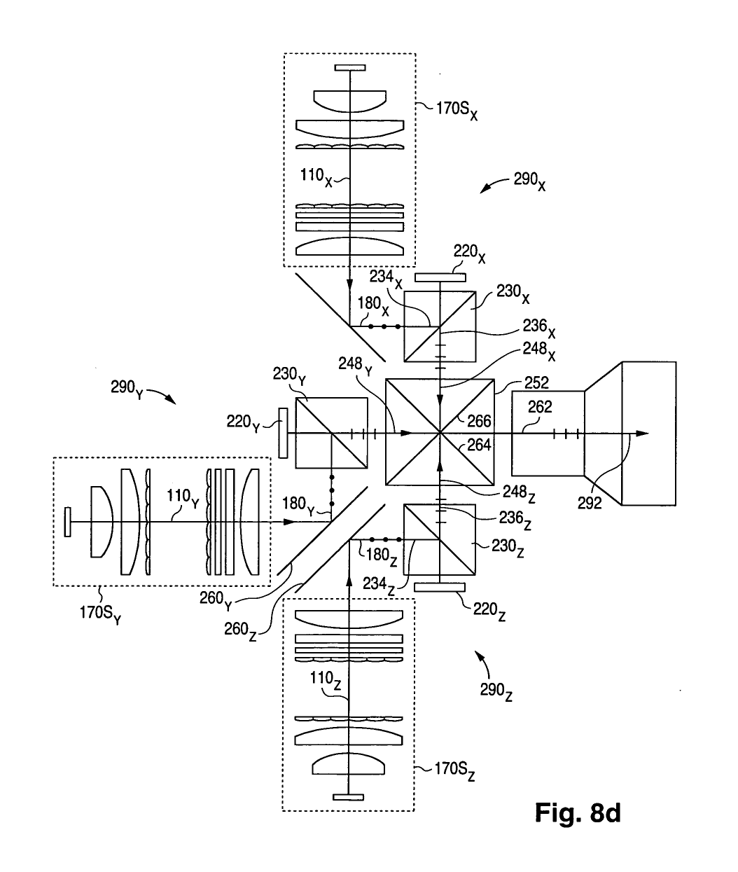

FIGS. 8a-8d respectively illustrate four LCD color light projectors which respectively utilize variations (or extended versions) of the LCD optical assemblies of FIGS. 7a-7d. In particular, the color projector of FIG. 8a, 8b, 8c, or 8d employs three variations of the LCD optical assembly of corresponding FIG. 7a, 7b, 7c, or 7d to respectively provide linearly polarized light of three different colors. The items (components and light fluxes) of each optical assembly in FIG. 8a, 8b, 8c, or 8d are identified by the reference symbols used above for the corresponding optical assembly in FIG. 8a, 8b, 8c, or 8d followed by a subscript “X”, “Y”, or “Z” to distinguish the three optical assemblies in each FIG. 8a, 8b, 8c, or 8d. In a typical implementation of the color projector of FIG. 8a, 8b, 8c, or 8d, one of the three optical assemblies provides linearly polarized red light, another of the optical assemblies provides linearly polarized green light, and the third optical assembly provides linearly polarized blue light.

Beginning with FIG. 8a, its color projector consists of three optical assemblies 250_{X}, 250_{Y}, and 250_{Z}, an X-cube beam combiner 252, and a projection lens device 254. Letting i be a letter that runs from X to Z, each optical assembly 250ᵢ consists of polarization-recovery illumination system 160Pᵢ, reflective LCD panel 220ᵢ, and a light-directing structure constituted with PBS 230ᵢ and a folding mirror 260ᵢ situated in front of illumination system 160Pᵢ at approximately a 45° angle to its optical axis 110ᵢ. Different from the optical assembly of FIG. 7a where first PBS optical axis 110 is substantially coincident with optical axis 110 of illumination system 160P, first optical axis 234ᵢ of PBS 230ᵢ is substantially perpendicular to optical axis 110ᵢ of system 160Pᵢ due to the presence of folding mirror 260ᵢ. The target area of LCD panel 220ᵢ is substantially perpendicular to first PBS optical axis 234ᵢ. X-cube beam combiner 252 and projection lens 254 have a common projection optical axis 262.

X-cube beam combiner 252 has a pair of dichroic mirrors 264 and 266 that intersect at approximately a 90° angle. Their faces are at approximately 45° angles to projection-system optical axis 262. Dichroic mirror 264 reflects linearly polarized light of the wavelength provided by optical assembly 250_{X} and transmits linearly polarized light of the wavelengths provided by optical assemblies 250_{Y} and 250_{Z}. Dichroic mirror 266 reflects linearly polarized light of the wavelength provided by optical assembly 250_{Z} and transmits linearly polarized light of the wavelengths provided by optical assemblies 250_{Y} and 250_{X}.

PBS 230_{X} is situated along one side of X-cube combiner 252. PBS 230_{Z} is situated along the opposite side of X cube 252. PBS 230_{Y} is situated along a third side of X cube 252. Projection lens device 254 is situated along the side of X cube 252 opposite its third side. Second optical axis 236ᵢ of each PBS 230ᵢ is at approximately a 45° angle to each dichroic mirror 264 or 266.

Divergent light fluxes 166ᵢ of p linearly polarized largely light reflect off folding mirror 260ᵢ in optical assembly 250ᵢ, making roughly a 90° bend, and travel through PBS 230ᵢ generally along its first optical axis 234ᵢ to LCD panel 220ᵢ. Upon being modulated at LCD panel 220ᵢ, the incident p linearly polarized light is partly reflected back as modulated beam 238ᵢ of s linearly polarized light. The beam-splitting plate in PBS 230ᵢ largely reflects s linearly polarized modulated light beam 238ᵢ, causing it to make roughly a 90° bend. Modulated light beam 238ᵢ then travels generally along second PBS optical axis 236ᵢ.

Modulated assembly-output light beams 238_{X}, 238_{Y}, and 238_{Z} enter X-cube combiner 252 at the three respective X-cube sides where PBSs 230_{X}, 230_{Y}, and 230_{Z} are situated. Light beam 238_{X} then largely reflects off dichroic mirror 264, making roughly a 90° bend, and travels out of X cube 252 generally along projection optical axis 262 into projection lens device 254. In so doing, light beam 238_{X} is normally largely transmitted through dichroic mirror 266. Light beam 238_{Z} similarly largely reflects off mirror 266, making roughly a 90° bend, and travels out of X cube 252 generally along projection axis 262 into projection lens 254. Light beam 238_{X} is also normally largely transmitted through dichroic mirror 264 during this action. Light beam 238_{Y} is largely transmitted through mirrors 264 and 266 and travels out of X cube 252 generally along projection axis 262 into projection lens 254. Since all of light beams 238_{X}, 238_{Y}, and 238_{Z} enter projection lens 254 along projection axis 262, they combine to form a composite beam 268 of s linearly polarized color light traveling generally along axis 262. Projection lens 254 then projects composite beam 268 onto a suitable screen.

The color projector of FIG. 8b consists of three optical assemblies 270_{X}, 270_{Y}, and 270_{Z}, X-cube beam combiner 252, and projection lens device 254. Each optical assembly 270ᵢ is formed with polarization-recovery illumination system 160Sᵢ, reflective LCD panel 220ᵢ, and a light-directing structure consisting of PBS 230ᵢ and folding mirror 260ᵢ situated in front of illumination system 160Sᵢ at approximately a 45° angle to its optical axis 110ᵢ. Different from the optical assembly of FIG. 7b where first PBS optical axis 234 is substantially coincident with optical axis 110 of illumination system 160S, first PBS optical axis 234ᵢ is substantially perpendicular to optical axis 110ᵢ of system 160Sᵢ. The target area of LCD panel 220ᵢ is substantially perpendicular to second PBS optical axis 236ᵢ. Subject to these items, the color projector of FIG. 8b is configured the same as the color projector of FIG. 8a.

Divergent light fluxes 166ᵢ of s linearly polarized light largely reflect off folding mirror 260ᵢ in optical assembly 270ᵢ, making roughly a 90° bend, and travel to PBS 230ᵢ generally along its first optical axis 234ᵢ. The beam-splitting plate in PBS 230ᵢ largely reflects divergent light fluxes 166ᵢ, causing them to make roughly a 90° bend and travel to LCD panel 220ᵢ. Upon being modulated at LCD panel 220ᵢ, the incident s linearly polarized light of light fluxes 166ᵢ is partly reflected back as modulated beam 240ᵢ of p linearly polarized light traveling generally along second PBS optical axis 236ᵢ.

Modulated assembly-output light beams 240_{X}, 240_{Y}, and 240_{Z} enter X-cube combiner 252 at the three respective X-cube sides where PBSs 230_{X}, 230_{Y}, and 230_{Z} are situated. Light beam 240 then largely reflects off dichroic mirror 264, making roughly a 90° bend, and travels out of X cube 252 generally along projection optical axis 262 into projection lens device 254. Light beam 240_{Z} largely reflects off mirror 266, making roughly a 90° bend, and travels out of X cube 252 generally along projection axis 262 into projection lens 254. In the course of being projected along projection axis 262 toward lens 254, light of each beam 240_{X} or 240_{Z} also largely passes through mirror 266 or 264. Light beam 240_{Y} is largely transmitted through mirrors 264 and 266 and travels out of X cube 252 generally along projection axis 262 into projection lens 254. Inasmuch as light beams 240_{X}, 240_{Y}, and 240_{Z} all enter projection lens 254 along projection axis 262, they combine to form a composite beam 272 of p linearly polarized color light traveling generally along axis 262. Composite beam 272 is projected by projection lens 254 onto a suitable screen.

The color projector of FIG. 8c consists of three optical assemblies 280_{X}, 280_{Y}, and 280_{Z}, X-cube beam combiner 252, and projection lens device 254. Each optical assembly 280ᵢ consists of polarization-recovery illumination system 170Pᵢ, reflective LCD panel 220ᵢ, and a light-directing structure constituted with PBS 230ᵢ and folding mirror 260ᵢ situated in front of illumination system 170Pᵢ at approximately a 45° angle to its optical axis 110ᵢ. Different from the optical assembly of FIG. 7c where first PBS optical axis 234 is substantially coincident with optical axis 110 of illumination system 170P, first PBS optical axis 234ᵢ is substantially perpendicular to optical axis 110ᵢ of system 170Pᵢ. Subject to these items, the projector of FIG. 8c is configured the same as the projector of FIG. 8a.

Upon exiting illumination systems 170P_{X}, 170P_{Y}, and 170P_{Z}, divergent light fluxes 180_{X}, 180_{Y}, and 180_{Z} of p linearly polarized light respectively follow the same routes, and undergo the same changes, in the projector of FIG. 8c that divergent light fluxes 166_{X}, 166_{Y}, and 166_{Z} of p linearly polarized light respectively follow and undergo in exiting illumination systems 160P_{X}, 160P_{Y}, and 160P_{Z} of the projector of FIG. 8a. Accordingly, parts of light fluxes 178_{X}, 178_{Y}, and 178_{Z} are respectively converted into modulated beams 246_{X}, 246_{Y}, and 246_{Z} of s linearly polarized light. Modulated light assembly-output beams 246_{X}, 246_{Y}, and 246_{Z} all enter projection lens 254 along projection axis 262 and combine to form a composite beam 282 of s linearly polarized color light traveling generally along projection optical axis 262. Projection lens 254 then projects composite beam 282 onto a suitable screen.

The color projector of FIG. 8d consists of three optical assemblies 290_{X}, 290_{Y}, and 290_{Z}, X-cube beam combiner 252, and projection lens device 254. Each optical assembly 290ᵢ is formed with polarization-recovery illumination system 170Sᵢ, reflective LCD panel 220ᵢ, and a light-directing structure consisting of PBS 230ᵢ and folding mirror 260ᵢ situated in front of illumination system 170Sᵢ at approximately a 45° angle to its optical axis 110ᵢ. Different from the optical assembly of FIG. 7d where first PBS optical axis 234 is substantially coincident with optical axis 110 of illumination system 170S, first PBS optical axis 234ᵢ is substantially perpendicular to optical axis 110ᵢ of system 170Sᵢ. Subject to these items, the projector of FIG. 8d is configured the same as the projector of FIG. 8b.

Upon exiting illumination systems 170S_{X}, 170S_{Y}, and 170S_{Z}, divergent light fluxes 180_{X}, 180_{Y}, and 180_{Z} of s linearly polarized light respectively follow the same routes, and undergo the same changes, in the projector of FIG. 8d that divergent light fluxes 166_{X}, 166_{Y}, and 166_{Z} of s linearly polarized light respectively follow and undergo in exiting illumination systems 160S_{X}, 160S_{Y}, and 160S_{Z} of the projector of FIG. 8b. Parts of light fluxes 178_{X}, 178_{Y}, and 178_{Z} are thereby respectively converted into modulated beams 248_{X}, 248_{Y}, and 248_{Z} of s linearly polarized light. Modulated assembly-output light beams 248_{X}, 248_{Y}, and 248_{Z} all enter projection lens 254 along projection axis 262 and combine to form a composite beam 292 of s linearly polarized color light traveling generally along projection optical axis 262. Composite beam 292 is projected by projection lens 254 onto a suitable screen.

Optical assemblies 250_{Y}, 270_{Y}, 280_{Y}, and 290_{Y} in the projectors of FIGS. 8a-8d preferably process green light and therefore provide assembly-output beams 238_{Y}, 240_{Y}, 246_{Y}, and 248_{Y} as s or p linearly polarized green light. Each of optical assemblies 250_{X}, 270_{X}, 280_{X}, and 290_{X} then processes one of red light and blue light and so as to provide assembly-output beams 238_{X}, 240_{X}, 246_{X}, and 248_{X} as s or p linearly polarized red or blue light. Each of optical assemblies 250_{Z}, 270_{Z}, 280_{Z}, and 290_{Z} processes the other of red light and blue light so as to provide assembly-output beams 238_{Z}, 240_{Z}, 246_{Z}, and 248_{Z} as s or p linearly polarized blue or red light.

While the invention has been described with reference to preferred embodiments, this description is solely for the purpose of illustration and is not to be construed as limiting the scope of the invention claimed below. For instance, each optical assembly 170Pᵢ in the color projector of FIG. 8c can be replaced with optical assembly 170P* in which input section 172A of light integrator 172 consists solely of first lens array 200 and in which output section 172B of integrator 172 consists of second lens array 202 and focusing lens 204. Each optical assembly 170Sᵢ in the color projector of FIG. 8d can similarly be replaced with optical assembly 170S* in which integrator input section 172A consists solely of first lens array 200 and in which integrator output section 172B consists of second lens array 202 and focusing lens 204.

A half-wave retardation plate (not shown) may be inserted between any PBS 230i and the adjacent face of X-cube combiner 252 in the color projector of FIG. 8a, 8b, 8c, or 8d. In the projector of FIG. 8a or 8c, the half-wave retardation plate largely converts s linearly polarized light beam 238ᵢ or 246ᵢ into a beam of p linearly polarized light that X cube 252 combines with each other beam 238ᵢ or 246ᵢ or similarly produced beam of p linearly polarized light to form a composite beam of color light having linearly polarized components traveling generally along projection optical axis 262. The half-wave retardation plate similarly largely converts p linearly polarized light beam 240ᵢ or 248ᵢ in the projector of FIG. 8b or 8d into a beam of s linearly polarized light that X cube 252 combines with each other beam 240ᵢ or 248ᵢ or similarly produced beam of s linearly polarized light to form a composite beam of color light having linearly polarized components traveling along projection axis 262.

The color light beam consists of mixed p and s linearly polarized color components when one or two half-wave retardation plates are employed in any of these variations of the projector of FIG. 8a, 8b, 8c, or 8d. In one example, one half-wave retardation plate is placed between PBS 230_{X} and the adjacent face of X-cube beam combiner 252 while another half-wave retardation plate is placed between PBS 230_{Z} and the adjacent face of X cube 252 on the opposite side of X cube 252. The resultant color beam traveling generally along projection axis 262 is then of mixed psp linear polarization in the variation of the projector of FIG. 8a or 8c and of mixed sps linear polarization in the variation of the projector of FIG. 8b or 8d.

Plano-convex lenses 206 or 208 can be replaced with fully convex lenses. In light integrator 162 and in the variation of light integrator 172 where output section 172B contains focusing lens 204 and second lens array 202 formed with largely identical lenses 208, the combination of focusing lens 204 and second lens array 202 can be replaced with a lens array consisting of lenses tailored to direct (or focus) divergent partial light fluxes directly on target location 124. Various modifications and applications may thus be made by those skilled in the art without departing from the true scope of the invention as defined in the appended claims.

What is claimed is:

1. An illumination system comprising:
a light source having a light reflector;
a collimator for collimating light provided from the light source;
a quarter-wave retardation plate for transmitting light collimated by the collimator, the so-transmitted light comprising a pair of orthogonal linearly polarized components of respective first and second linear polarization types; and
a light-reflective linear polarizer for transmitting light of the component of the first linear polarization type and reflecting light of the component of the second linear polarization type, such reflected light being transmitted back through the retardation plate and being converted by it into circularly polarized light which is of a first handedness and which is directed by the collimator to the light reflector to be reflected and thereby converted into circularly polarized light of a second handedness opposite to the first handedness, such circularly polarized light of the second handedness being collimated by the collimator, being subsequently transmitted through the retardation plate, and being converted by it into linearly polarized light which is of the first linear polarization type and which is transmitted through the polarizer.

2. A system as in claim 1 wherein the light source comprises a light-emitting diode.

3. A system as in claim 2 wherein at least one metallic electrode of the light-emitting diode constitutes at least part of the light reflector.

4. A system as in claim 1 wherein the collimator comprises at least one lens.

5. A system as in claim 1 further including an integrator for causing a plurality of partial fluxes of composite light collimated by the collimator and transmitted through the retardation plate and the polarizer to be mixed for providing a target location with integrated linearly polarized light of more uniform illumination than the composite light.

6. A system as in claim 5 wherein the integrator comprises a group of lens arrays.

7. A system as in claim 5 wherein the integrator comprises:
a first lens array comprising a like plurality of first lenses respectively corresponding to the partial fluxes, each first lens transmitting light of the corresponding partial flux and causing that light to converge into a convergent flux of light; and
a second lens array comprising a like plurality of second lenses respectively corresponding to the convergent fluxes, each second lens transmitting light of the corresponding convergent flux to produce a divergent flux of light that mixes with the other divergent fluxes.

8. A system as in claim 7 wherein each first lens has a pair of opposite largely planar and convex sides, the planar sides generally facing the second lens array.

9. A system as in claim 8 wherein each second lens has a pair of opposite largely planar and convex sides, the convex sides of the second lenses generally facing the first lens array.

10. A system as in claim 7 further including a focusing lens for focusing light of the divergent fluxes on the target location.

11. A system as in claim 7 wherein:
the first lens array is situated between the polarizer and the target location; and
the second lens array is situated between the first lens array and the target location.

12. A system as in claim 11 further including a focusing lens for focusing light of the divergent fluxes on the target location, the focusing lens situated between the second lens array and the target location.

13. A system as in claim 7 wherein:
the first lens array is situated between the collimator and the retardation plate; and
the second lens array is situated between the first lens array and the retardation plate.

14. A system as in claim 13 further including a focusing lens for focusing light of the divergent fluxes on the target location, the focusing lens situated between the polarizer and the target location.

15. A system as in claim 7 wherein:
the first lens array is situated between the collimator and the retardation plate; and
the second lens array is situated between the polarizer and the target location.

16. A system as in claim 15 further including a focusing lens for focusing light of the divergent fluxes on the target location, the focusing lens situated between the second lens array and the target location.

17. A light projector comprising:
a plurality of optical assemblies, each comprising:
(a) an illumination system as in claim 1,
(b) a light-reflective liquid-crystal display (“LCD”) panel; and
(c) light-directing structure for directing linearly polarized light of the first linear polarization type transmitted through the polarizer of the illumination system to the LCD panel and for directing a resultant beam of modulated light reflected by the LCD panel generally along a selected path, the light source in each illumination system providing visible light of a different color than the light source in each other illumination system;
a beam combiner for combining light of the beams of modulated light to produce a composite beam of light; and
a projection lens device for projecting the composite beam.

18. A projector as in claim 17 wherein each illumination system further includes an integrator for causing a plurality of partial fluxes of composite light collimated by that system's collimator and transmitted through that system's retardation plate and that system's polarizer to be mixed for providing a target location with integrated linearly polarized light of more uniform illumination than the composite light.

19. An illumination method comprising:
collimating light;
causing such collimated light to be transmitted through a quarter-wave retardation plate wherein the so-transmitted light comprises a pair of orthogonal linearly polarized components of respective first and second linear polarization types;
transmitting light of the component of the first linear polarization type through a light-reflective polarizer;
reflecting light of the component of the second linear polarization type off the polarizer;
causing such reflected light to be transmitted back through the retardation plate and converted by it into circularly polarized light of a first handedness;
reflecting such circularly polarized light of the first handedness to convert it into circularly polarized light of a second handedness opposite to the first handedness;
collimating such circularly polarized light of the second handedness;
causing such collimated circularly polarized light of the second handedness to be transmitted through the retardation plate and converted by it into linearly polarized light of the first linear polarization type; and
transmitting such linearly polarized light of the first linear polarization type through the polarizer.

20. A method as in claim 19 wherein:
the act of collimating light comprises collimating light provided by a light source having a light reflector; and
the act of reflecting such circularly polarized light of the first handedness comprises reflecting that light off the light reflector.

21. A method as in claim 19 further including causing a plurality of partial fluxes of composite light transmitted through the retardation plate and the polarizer to be mixed for providing a target location with integrated linearly polarized light of more uniform illumination than the composite light.

22. A system as in claim 21 wherein the act of causing the partial fluxes to be mixed comprises using at least one lens array to cause the mixing.
